(19) United States
(12) Patent Application Publication
(10) Pub. No.: US 2010/0288000 A1
(43) Pub. Date: Nov. 18, 2010

(54) ELECTRONIC LOCK

(75) Inventor: Jörg Reichl, Velbert (DE)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Steinbach & Vollmann GmbH & Co., KG, Heiligenhaus (DE)

(21) Appl. No.: 12/678,940

(22) PCT Filed: May 7, 2008
(86) PCT No.: PCT/EP08/03635

§ 371 Date: May 11, 2010

(30) Foreign Application Priority Data
Sep. 20, 2007 (EP) 07018461.9

(51) Int. Cl. E05B 47/06; E05B 63/00

(52) U.S. Cl. 70/277

(57) ABSTRACT

The invention relates to an electronic lock, in particular a safety lock. In order to provide an electronic lock which, while being resistant to manipulation, is of simplified construction, the invention proposes a lock having a bolt (6), having a bolt-displacing device (9) connected thereto, having a blocking member (5) arranged at the bolt-displacing device (9), and having a blocking element (10) which interacts with the blocking member (5), the blocking element (10) being designed run into the movement path (12) which is described by the blocking member.

The invention relates to an electronic lock, in particular an electronic safety lock.

Electronic locks in general and electronic safety locks in particular are well known in prior art, wherefore a certain confirmation by documents is regarded as being not necessary at this point.

Locks and thus also electronic locks comprise a bolt. This bolt is movably constructed and is coupled to a bolt-displacing device enabling a user to selectively move the bolt into one of at least two end positions by means of a corresponding actuating device. The lock is blocked in a first end position of the bolt and open, i.e. unblocked, in a second end position of the bolt.

In contrast to a generic look, the distinctive feature of a safety lock inter alia is that the movement of the bolt can be blocked so that the bolt can be moved only after unblocking, whereby unblocking of the bolt is only possible by authorized users. For blocking the bolt, it is known from prior art to use a blocking member. This blocking member can either be blocked or released. But the bolt can be moved only in the released condition, since only in this condition the locking member can be moved freely. In the blocked condition of the locking member, its movement and thus also the movement of the bolt is not possible. The release and/or blocking of the locking member can be performed electrically and/or mechanically.

Although safety locks known from prior art have proven effective in everyday practical use, there is a need for improvement, particularly with regard to manipulation security. Moreover, in prior art locks, the interaction of the bolt on the one hand and the blocking member on the other hand mostly is mechanically very complex thus requiring complicated and expensive mounting.

It therefore is an object of the present invention to provide an electronic lock which is simplified manipulation security at the same time.

For the solution of this object the invention proposes an electronic lock, in particular an electronic safety lock, having a bolt, a bolt-displacing device connected thereto, a blocking member arranged at the bolt-displacing device and a blocking element which interacts with the blocking member, the blocking element being designed to run into the movement path which is described by the blocking member.

The special feature of the lock according to the invention is to be seen in the interaction of the blocking member on the one hand and the blocking element on the other hand. Unlike from locks which are known from prior art, the blocking member is arranged at and movable with the bolt-displacing device. Blocking of the bolt is not achieved by the blocking member directly blocking a possible movement of the bolt. The invention rather provides for a blocking element running into the movement path of the blocking member, i.e. into the movement path which is described by the blocking member, whereby the blocking element is designed for linear movement. But also a blocking element, which is designed for pivoting and which can be pivotally moved into the movement path, can be imagined and is regarded as being covered by the concept of the invention.

The embodiment according to the invention is characterized by its simplicity. Only two components are provided, namely the locking member on the one hand and the locking element on the other hand, which enable blocking of the bolt in a simple manner and secure from manipulation. For example, the blocking element for example is designed for a linear movement, thus requiring a movement space which is relatively small compared to a rotary arrangement so that the lock according to the invention can be comparatively compact. Incidentally, the lock according to the invention is characterized in that the blocking element can run into the movement path of the blocking member for the sake of blocking the movement of the blocking member and thus the movement of the bolt. Accordingly, a free movement of the blocking member can be blocked by the blocking element. Free movement of the blocking member and thus free movement of the bolt are not possible in the blocked position of the blocking element. The bolt thus is in its blocked position that can be released only by a linear displacement of the blocking element which is only possible by an authorized person. The lock according to the invention is secure from manipulation and simultaneously has a simple construction. Neither the bolt nor the blocking member can be forcibly moved. The blocking element in its blocked position effectively prevents from any possibility of displacing both, the bolt and the blocking element. Thereby the blocking element in its blocked position can preferably be supported by a support bearing so that any unintended movement of the blocking element to a releasing position is impossible even by an impacting force.

In a particular embodiment of the invention, the blocking member is an element which is spring-loaded, for instance in the form of a stud, piston, pin or the like. In a pivoting construction, the blocking member can also be annular. The blocking member, which is for instance formed as a stud, is constructed as a separate component which is inserted for instance in a corresponding bore of the bolt-displacing device in its mounted state. The construction of the blocking member as a stud is particularly simple and easy to mount. Moreover, the blocking member being is formed as a stud can be easily replaced if necessary.

According to a further feature of the invention, the blocking member is designed so as to be movable in a direction transverse to the moving direction of the bolt. A difference must be made between the blocked position on the one hand and the unblocked position on the other hand. In the blocked position, the blocking member is forced in its normal position by spring preload. For moving the blocking member to the unblocked position, the blocking member must be displaced against the spring preload, for which purpose a ramp element is provided as described in the following. This ramp element engages the blocking member when the blocking element is in the condition of its unblocked position in which the blocking element does not block the movement of the blocking member. Consequently, in the unblocked position of the blocking element, the blocking member does not interact with the blocking element, but instead with a ramp element. This ramp element allows displacing the blocking member against the spring force and moving it to its unblocked position. This embodiment is very simple in construction and prone to dysfunction.

According to a further feature of the invention, the blocking element is arranged at a displacing member, for instance, on one end side of a bar-shaped displacing member. The above-mentioned ramp element is arranged between the displacing member on the one hand and the blocking element on the other hand. The displacing member is preferably bar-shaped and forms together with the ramp element and the blocking member a one-piece structural unit that may be referred to as an displacing device. By means of the displacing member, i.e. the displacing device, the blocking element or the ramp element can run alternatively into the movement path which is described by the blocking member. If the blocking element is within the movement path which is described by the blocking member, the blocking member is blocked in its movement, i.e. the lock is in its blocked position. In this blocked position of the lock, it is not possible to move the bolt. On the other hand, if the ramp element is brought into the movement path of the blocking element, the lock can be moved to its released position by forcing the blocking member, which is movably arranged at the bolt-displacing device, upwards against the spring preload by the ramp element. In the upwardly forced position of the blocking member, the lock is in its unlocked position, i.e. the bolt is completely retracted. Hence, the lock is “open”. Preferably, in the course of the opening movement of the bolt, the locking element is displaced back to its locking position. Hence, the lock is advantageously self-locking.

According to an alternative embodiment of the invention, the displacing device which is constituted by the blocking element, displacing member and ramp element can also be formed as a structural unit having a circular cross section which structural unit is rotatably arranged about an axis of rotation. According to this embodiment of the invention, the displacing member, i.e. the displacing device, must be rotated in order to run selectively either the blocking element or the ramp element into the movement path which is described by the blocking member.

According to a further feature of the invention, the displacing member, i.e. the displacing device, is configured for a linear movement or for rotation about an axis of rotation, respectably, by means of a drive unit. Preferably, the drive unit is an electric drive unit, for instance a linear drive. Other kinds of drivers may be considered. The drive unit may for instance comprise a piezo element, for instance in the form of an elliptec motor. The use of a piezo element is particularly preferred because security from manipulation is increased if a drive unit is used which includes a piezo element. In the case of manipulation it is not only required to bridge the electric circuit for the control unit for controlling the drive but it is also necessary to ensure the setting of the correct frequency for the piezo element. Simple bridging of the drive unit is thus not possible which increases security from manipulation of the entire lock.

Preferably, the drive unit can be operated by an authorized person in case of need. Authorization is possible, for instance, by allowing switching of the drive unit only after the previous entry of a pin code. Other security mechanisms can be used as well. Important is that the drive unit can only be operated, i.e. switched, by an authorized person.

After being switched on, the drive unit provides for a displacement or rotation of the blocking element. Accordingly, the blocking element is withdrawn from the movement path of the blocking member, i.e. the existing blockage of the blocking member is released. The blocking member and thus the bolt can be freely moved now, whereby allowing the lock to be unlocked.

As long as the blocking element is in its initial position, i.e. not moved to the releasing position by means of the drive unit, the movement of the blocking member is blocked since the blocking element is located within the movement path which is described by the locking member. A movement of the locking member and thus unlocking of the bolt is not possible in this position of the blocking element. Accordingly, the lock cannot be unlocked without authorization, i.e. without actuating of the drive unit.

According to a particular embodiment of the invention, mechanical emergency unlocking device is provided. This mechanical emergency unlocking device allows opening or closing of the lock by means of a mechanically acting operating element such as a key, namely by avoiding the above-described drive unit for moving the blocking element. A mechanical emergency operation may be necessary if, for example, the drive unit for moving the blocking member is out of order, the electronic system for verifying of the authorization code is faulty, or the person who is authorized to open the lock does not remember the required authorization code.

The mechanical emergency unlocking device allows to position the blocking member manually in its position relative to the blocking element by a dedicated lever arm in such a manner that the blocking member can be guided past the blocking element even if the blocking element cannot be moved out of its blocking position due to a faulty operation of the electric and/or electronic system. Accordingly, by manually displacing of the blocking member, the bolt can be caused to open even if the blocking element is still in its blocking position.

A manual operation of the blocking member preferably is affected by using a key by which a tumbler arrangement can brought into the opening position in a manner known by the art, in which—and only this position—the operation of the blocking member is allowed.

Further features and advantages of the invention will become apparent from the following description with reference to the drawings. It is shown by:

FIG. 1 a top view of a first embodiment of the lock according to the invention in the unblocked position;

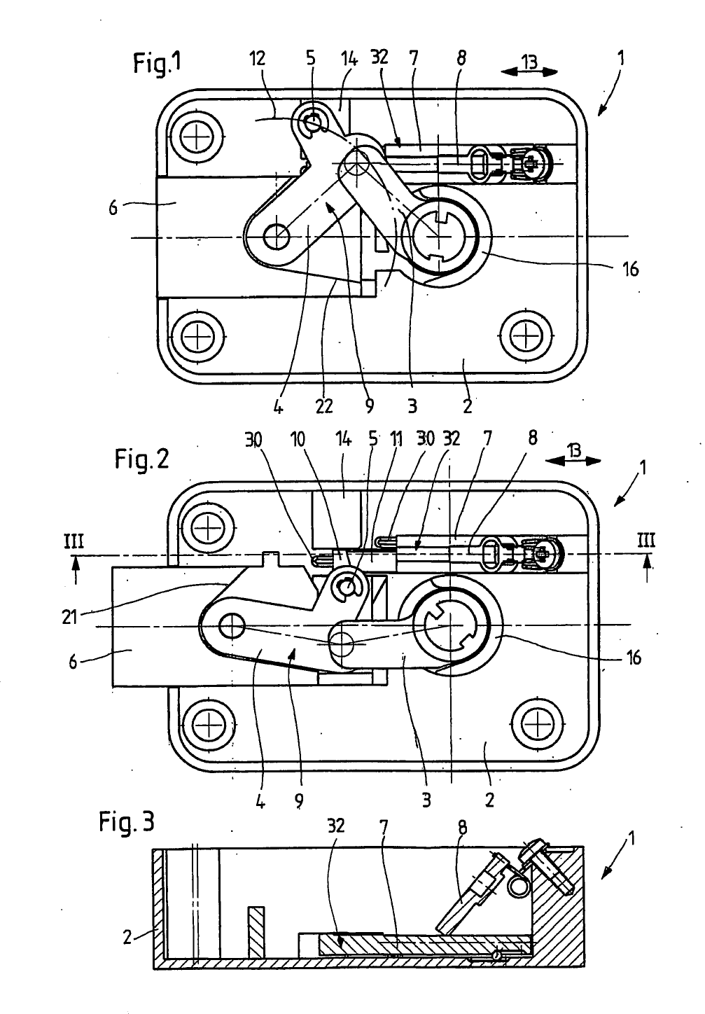

FIG. 2 a top view of the first embodiment of the lock according to the invention in the blocked position;

FIG. 3 a sectional view of the lock according to the invention taken along cutting line III-III in FIG. 2;

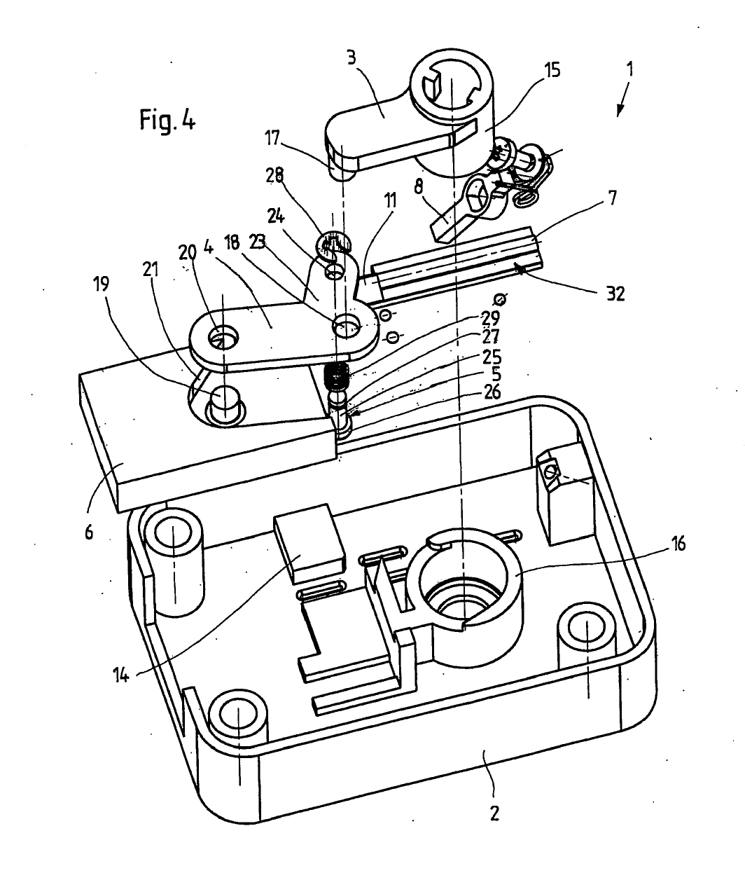

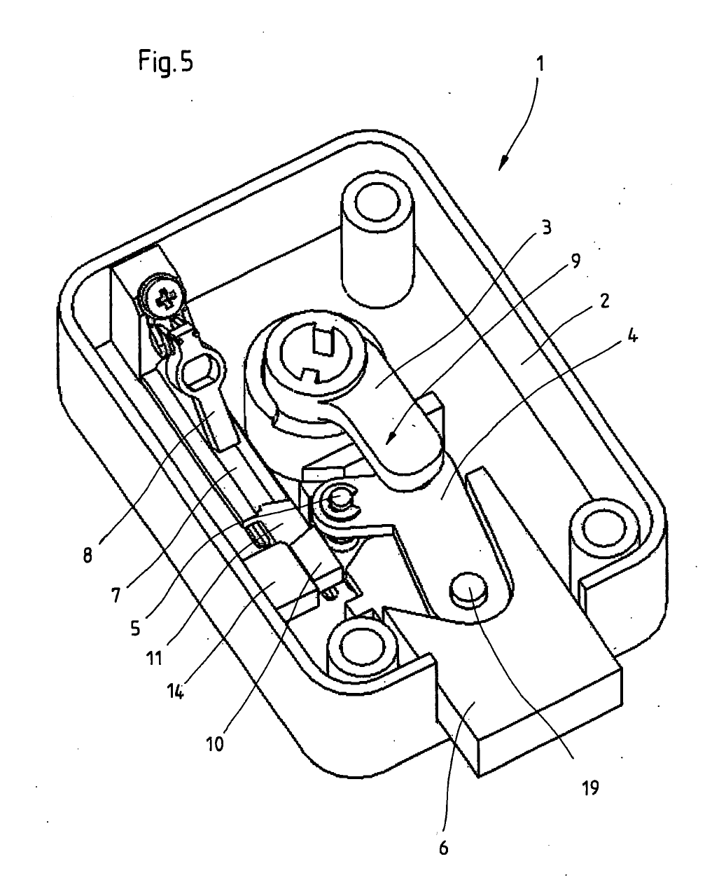

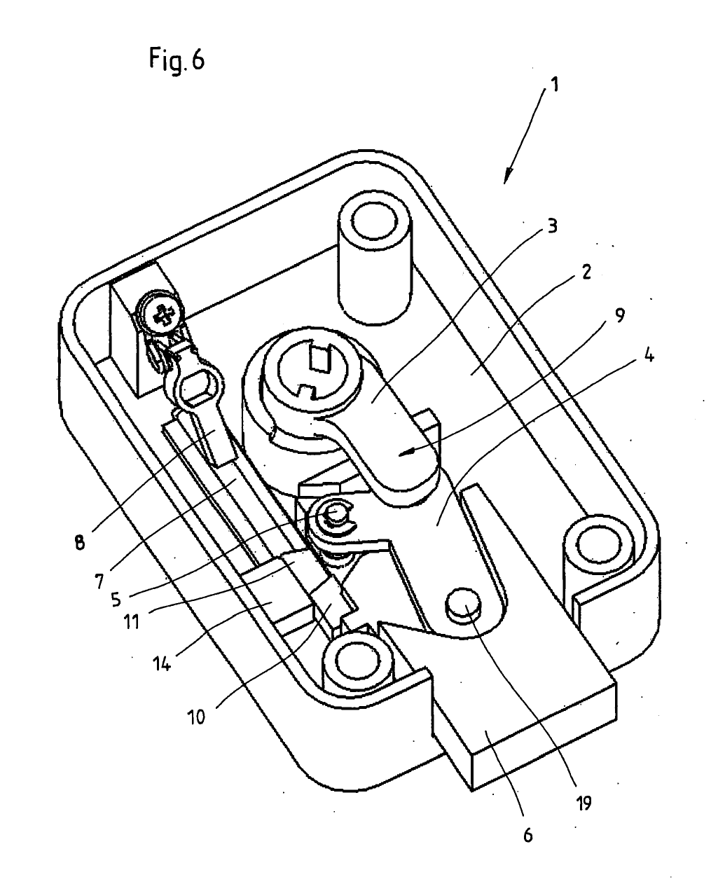

FIG. 4 an exploded view of the lock according to the invention in the first embodiment;

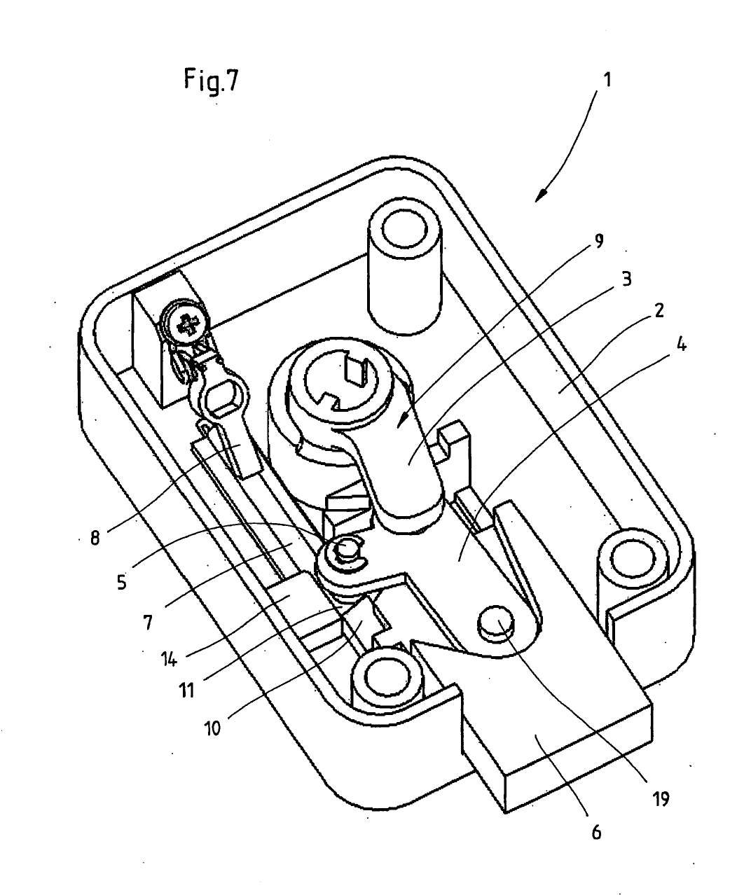

FIG. 5 a schematic perspective representation of the first embodiment of the lock according to the invention in the blocked position;

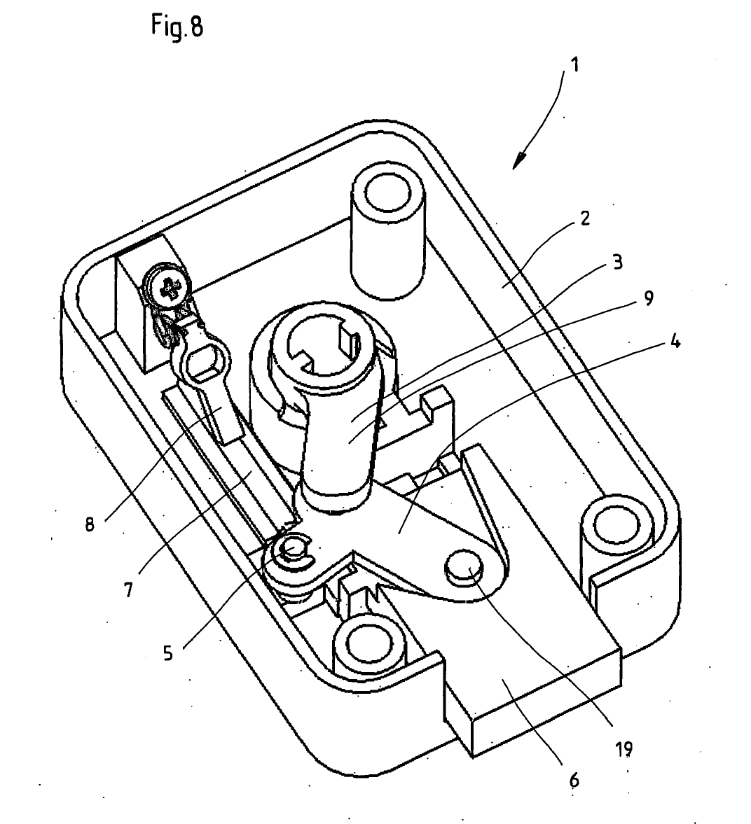

FIG. 6 a schematic perspective representation of the first embodiment of the lock according to the invention in the unblocked position;

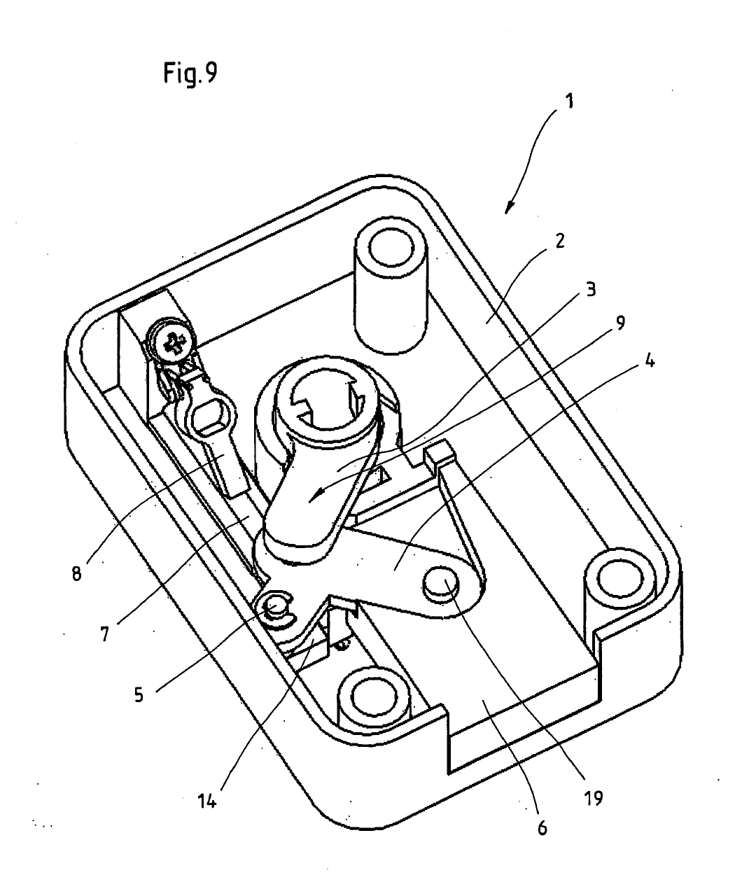

FIG. 7 a schematic perspective representation of the first embodiment of the lock according to the invention in a first position during the opening action;

FIG. 8 a schematic perspective representation of the first embodiment of the lock according to the invention in a second position during the opening action;

FIG. 9 a schematic perspective representation of the first embodiment of the lock according to the invention in the unblocked position;

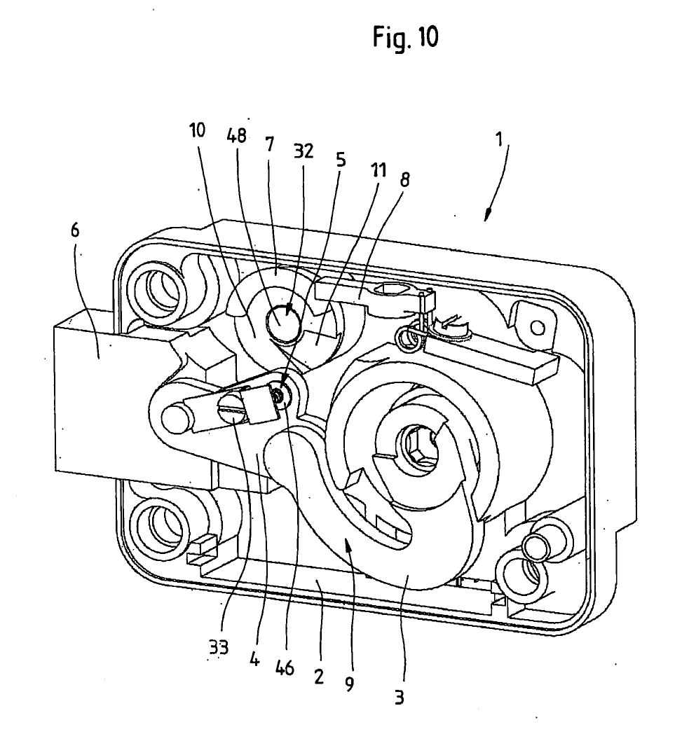

FIGS. 10 to 17 different views of the lock according to the invention in a second embodiment;

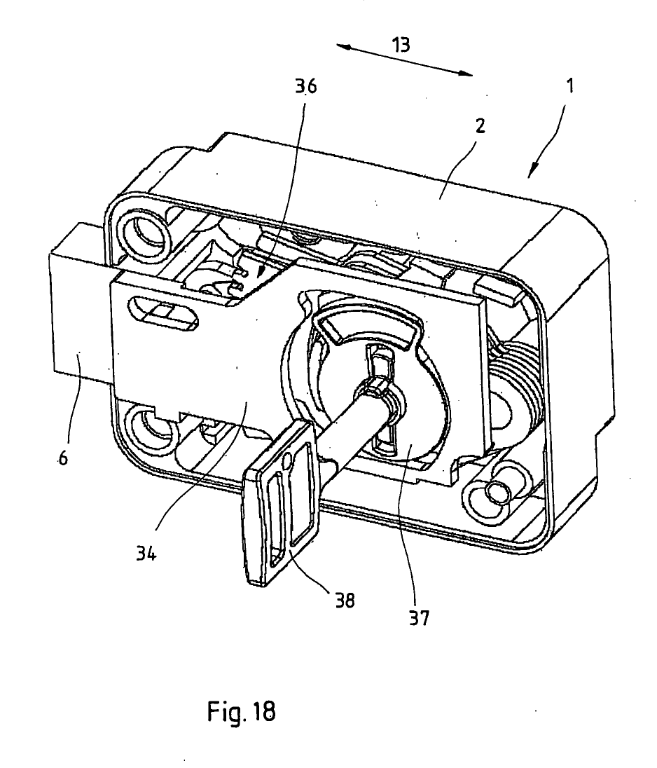

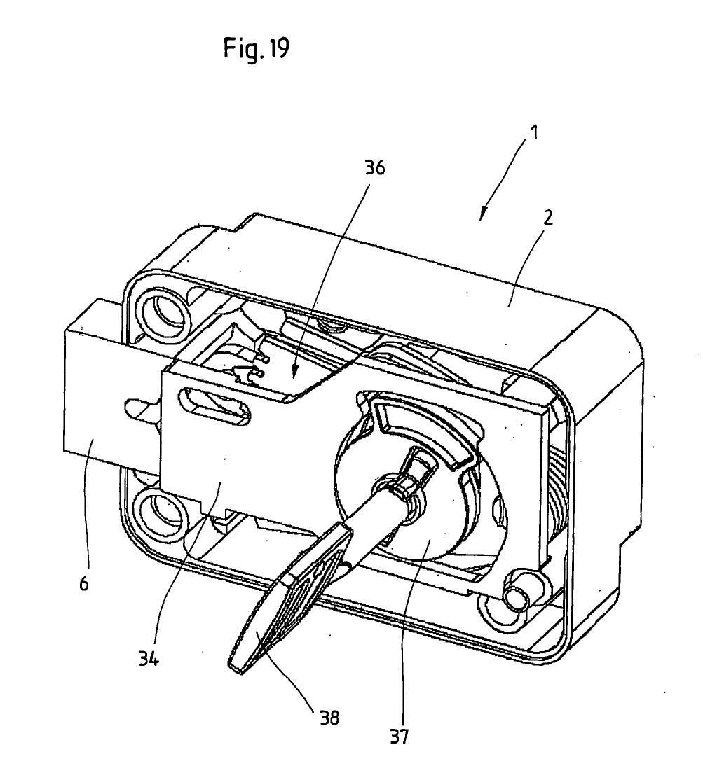

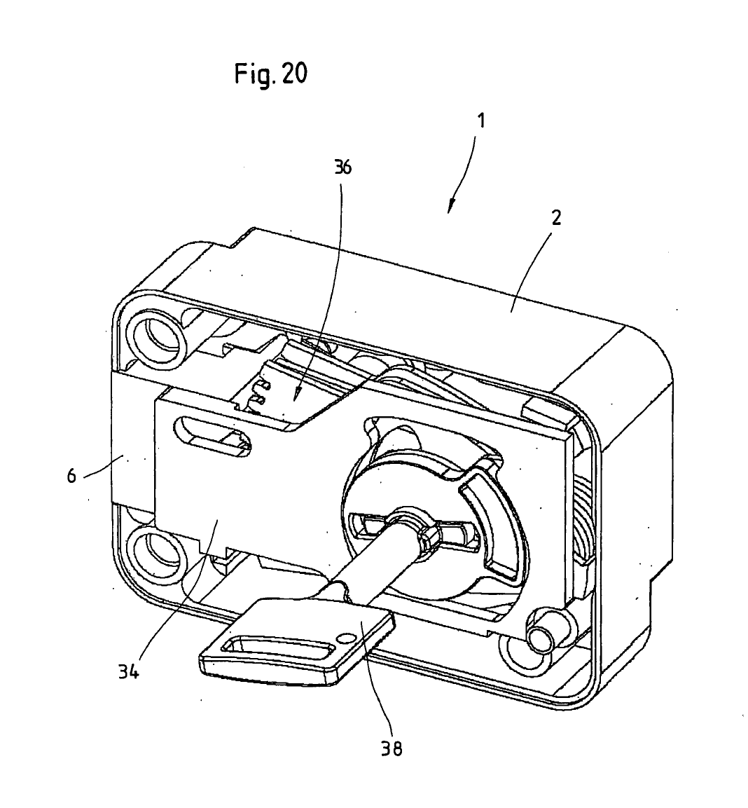

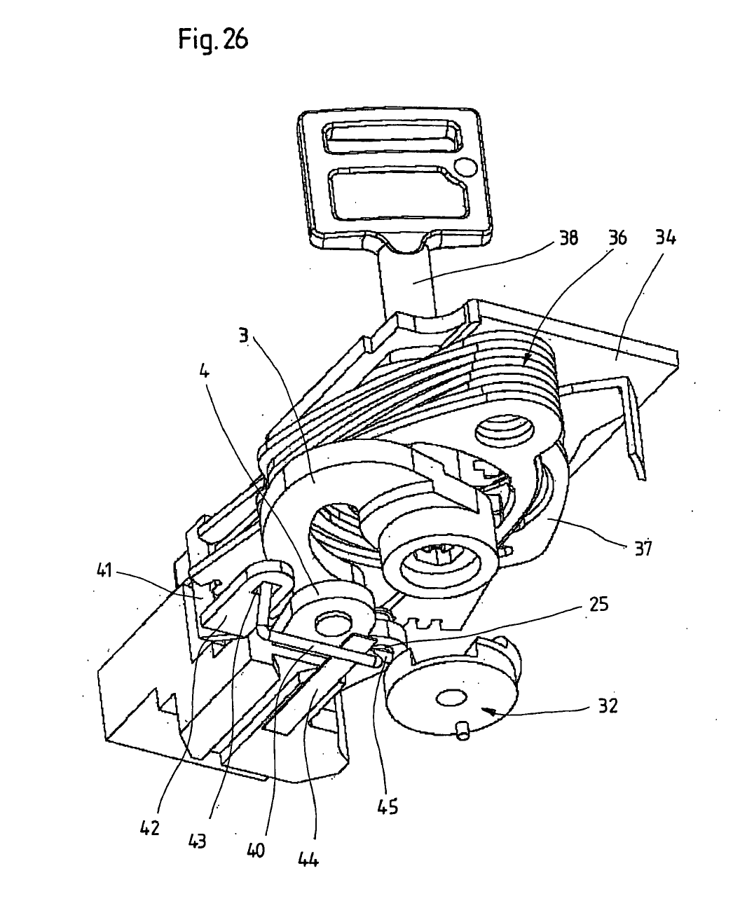

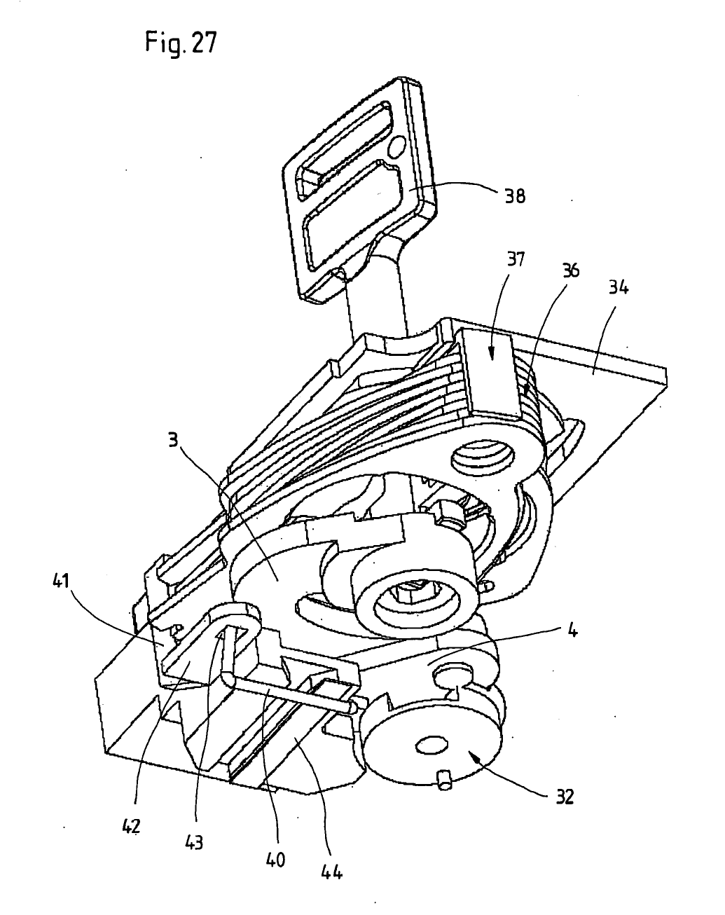

FIGS. 18 to 28 different views of the lock according to the invention in a third embodiment, which is an embodiment including a mechanical emergency unblocking device.

The figures illustrate various embodiments of the lock according to the invention. The FIGS. 1 to 9 show a first embodiment. The FIGS. 10 to 17 show a second embodiment and the FIGS. 18 to 28 show a third embodiment. The third embodiment is based upon a construction of the second embodiment and additionally comprises a mechanical emergency unlocking device. The third embodiment according to the FIGS. 18 to 28 is the preferred embodiment.

The lock 1 according to the invention in a first embodiment and its structural components can be best seen in the illustrations according to the FIGS. 1 to 4. The FIGS. 5 to 9 show in a schematic perspective view and in individual steps the movement of the lock 1 according to the invention from the blocked position illustrated in FIG. 5 to the unblocked position illustrated in FIG. 9.

The lock 1 according to the invention comprises a housing composed of two housing parts. For the purpose of clarity, only the housing part 2 is shown in the figures.

The lock 1 comprises a bolt 6 arranged for displacement in the moving direction 13 within the housing part 2. The bolt 6 can be moved back and forth in the moving direction 13. In the retracted position of the bolt 6 the lock 1 is unblocked. This position of the bolt 6 is illustrated in the FIGS. 1 and 9. The “closed”, i.e. the blocked, position of the lock is illustrated in the FIGS. 2 and 5. In the blocked position of the lock, the bolt is extended from the housing part 2 to the left in the moving direction 13 with respect to the drawing plane.

For operating the bolt 6, i.e. for moving the bolt 6 in the moving direction 13, a bolt-displacing device 9 is used, which is configured as a slider crank drive in the illustrated embodiment. The bolt-displacing device 9 comprises a pivoting arm 3 on the one hand and an articulated arm 4 on the other hand. As shown particularly in the FIGS. 1 and 2, the articulated arm 4 of the bolt-displacing device 9 is articulated to the bolt 6. The pivoting arm 3 in turn is articulated to the articulated arm 4, and on the other end of the articulated arm 4, a connecting piece 15 is provided which serves to the coupling of an operating element not further illustrated in the figures. This operating element, which is not further shown in the figures, can for instance be a door handle, door knob, or also the movable part of a lock cylinder, or the like. The design of this operating element is not important for the invention.

The connecting piece 15 is formed as a kind of sleeve and is inserted in the finally mounted state of the lock in bearing body 16, as this is shown especially in the FIGS. 1 and 2.

For a pivoting arrangement of the pivoting arm 3 on the articulated arm 4, the pivoting arm 3 comprises a pin 17 which engages in the finally mounted state in a correspondingly formed bore 18 of the articulated arm 4. On the other end side, the articulated arm 4 is arranged for pivoting on the bolt 6, at which end the bolt 6 comprises a pin-like appendix that engages in a second bore 20 of the articulated arm 4 in the mounted state.

When the operating element, which is not further illustrated in the figures, is actuated, the connecting piece 15 and thus the pivoting arm arranged thereon are pivotally moved from the blocked position of the lock shown in FIG. 2 to the right with respect to the drawing plane of FIG. 2. The bolt-displacing device 9, which is designed as a slider crank drive, thus causes the bolt 6 to retract into the housing part 2, as shown in FIG. 1 while the articulated arm 4 arranged at the bolt 6 is correspondingly pivoted. Corresponding limit stops 21 and 22 formed on the bolt 6 prevent possible excessive pivoting of the articulated arm 4.

As can be seen particularly in FIG. 4, the articulated arm 4 has a part 23 with a bore 24. In the finally mounted state of the lock 1, a blocking member 5 is inserted in this bore 24.

The blocking member 5 is designed as a kind of pin and includes a base body 25 and a head 26 integrally provided on the base body. On the opposite side of the head 26 the base body 25 includes a continuous groove 27 serving to receive a safety washer 28. As it can be seen in FIG. 4, the blocking member 5 is mounted to the articulated arm 4 with a pressure spring 29 interposed therebetween.

Furthermore, the lock 1 according to the invention includes a blocking element 10. The same is arranged on a displacing member 7 with a ramp element 11 interposed therebetween. In the preferred embodiment according to the drawing figures, the displacing member 7, the ramp element 11 and the blocking element 10 form a common structural unit which may be referred to as displacing device 32. This structural unit is linearly movable in the moving direction 13, namely, along a guiding contour 30 provided for this purpose. For a displacing movement of the displacing member 7 or the ramp element arranged thereon or the locking element 10 arranged thereon, a drive unit 8 is used which in the illustrated embodiment is designed as a piezo element in the form of an elliptec motor. By means of this drive unit 8, the adjusting member 7 and thus the ramp element 11 or the blocking element 10 are moved in the moving direction 13 to the left with respect to the drawing plane of FIG. 2.

A combined consideration of the FIGS. 1 and 2 shows that the blocking member 5 moves on a segment of a circle-like movement path 12 when the bolt-displacing device 9 is moved, i.e. when the articulated arm 4 is pivoted. In the blocked condition of the lock 1, which is illustrated in FIG. 2, the blocking element 10 run into this movement path 12 of the blocking member 5. Thus the blocking element 10 blocks the blocking member 5 in its movement, wherefore a pivotal movement of the blocking member 5 and thus a displacement of the bolt 6 are not possible. The blocking element 10 itself pushes against on the support bearing 14 so that any movement of the bolt 6 is blocked even if a higher external force is applied.

On the other hand, it is possible for an authorized person to put the drive unit 8 into operation by entering a pin code, for example, and thus displace the displacing member 7 to the left with respect to the drawing plane of FIG. 2. As a result of this displacement the blocking element 10 is moved out of the movement path 12 and the ramp element 11 arrives in the movement path 12. But differently from the blocking element 10, the ramp element 11 makes it possible, that the blocking member 5 is displaced with its head 26 following the ramp of the ramp element 11 against the spring force of the pressure spring 29. This possibility of displacement of the blocking member 5 against the action of the pressure spring 29 simultaneously enables a continued operation of the bolt-displacing device 9 so that the bolt 6 can be moved to the unblocking position of the lock 1 shown in FIG. 1.

The construction according to the invention is characterized by its simplicity. The lock is operated as usual via an operating element not further shown in the drawings. In the course of this and as a consequence of such an operation, the bolt 6 is reciprocated in the moving direction 13 via a bolt-displacing device. In the course of this back and/or forth movement of the bolt 6, a blocking member 5, which is thus coupled as regards its freedom of movement, is moved on a circular movement path 12. A blocking element 10 or a ramp element 11 can be moved into this movement path 12. If the blocking element 11 is positioned within the movement path 12, the bolt 6 cannot be moved to the unblocked position of the lock due to the blocking member 5 being blocked in its movement. This blockage is released only if the ramp element 11 instead of the blocking element 10 run into the movement path 12.

A transfer of the bolt 6 from the blocked position to the unblocked position is shown in a perspective view by the FIGS. 5 to 9. It can be clearly seen here that the blocking member 5 in the blocked position according to FIG. 5 is prevented by the blocking element 10 from a continued displacing movement. Only after the blocking element 10 has been moved from the blocked position to the unblocked position according to FIG. 6, the movement of the blocking member 5 and thus an opening movement of the bolt 6 can be continued. The unblocked position of the lock 1 is shown in FIG. 9.

A second embodiment of the lock according to the invention is shown in the FIGS. 10 to 17. Differently from the embodiment shown in the FIGS. 1 to 9, the second embodiment according to the FIGS. 10 to 17 shows a construction of the lock which comprises a rotatable displacing device 32.

As shown by various views in the FIGS. 10 to 17, the lock 1 according to a second embodiment of the invention also comprises a bolt 6 that is arranged for displacement inside a housing part 2. This bolt is connected to a bolt-displacing device 9 in the manner already described above. The articulated arm 4 of the bolt-displacing device 9 carries the already described blocking member 5, while the blocking member 5 is somewhat differently designed in this second embodiment.

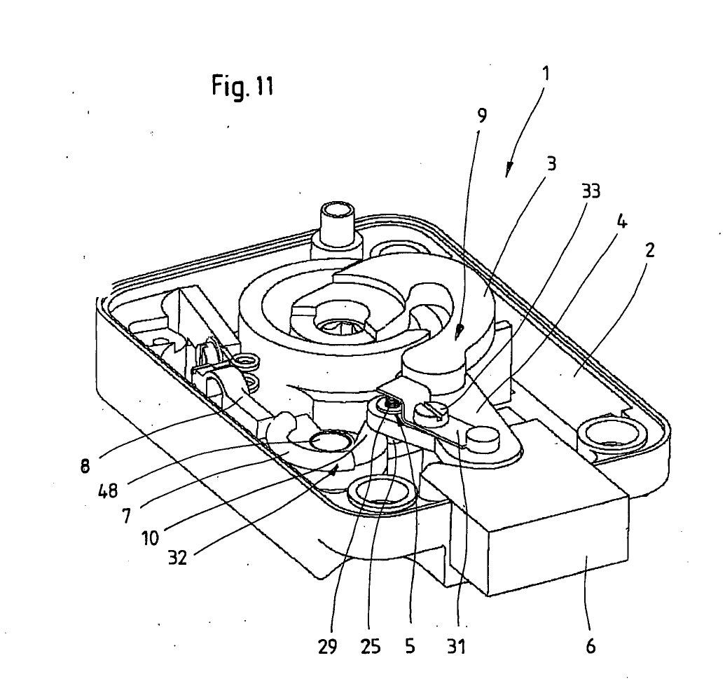

The blocking member 5 according to the second embodiment comprises a base body 25 which is designed as a pipe section that is closed on side. On the other side, the pipe section has a collar 46 as it is shown for example in FIG. 10. In the mounted state, the base body 25 of the blocking member 5 is inserted in a dedicated bore of the articulated arm 4. The length of the base body 25 exceeds the thickness of the articulated arm 4 with the result that the base body 25 of the blocking member 5 projects from the articulated arm 4 on the bottom side thereof with respect to the drawing plane of FIG. 11.

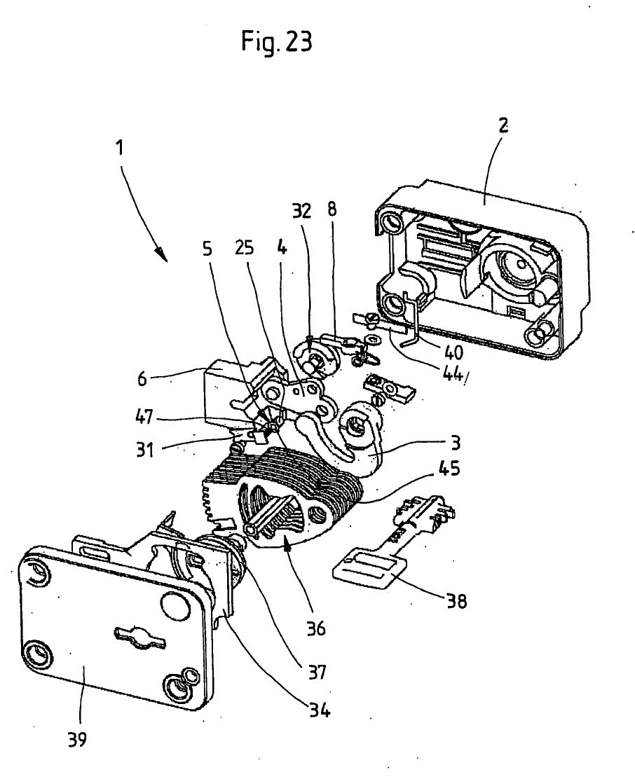

On the upper side of the articulated arm 4, referred to the drawing plane of FIG. 11, a retaining plate 31 is fixed by means of a screw 33. An angled part of this retaining plate 31 overtops the base body 25 of the blocking member 5. The angled part of the retaining plate 31 carries a guiding pin 47 not further shown which plunges into the base body 25 that is formed as a pipe section. This guiding pin 47, which can be seen particularly in the illustration in FIG. 23, provides for a guided movement of the base body 25 of the blocking member 5 upwards and downwards with respect to the drawing plane of FIG. 11. The base body 25 of the blocking member 5 is put under a spring preload, for which purpose a spring 29 surrounding the guiding pin 47 is arranged between the collar 46 of the blocking member 5 on the one hand and the retaining plate 31 on the other hand, as it can be seen for example in the illustration according to FIG. 11.

As it should be clear from the above explanation, the base body 25 of the blocking member 5 is capable of moving upwards and downwards relative to the articulated arm 4 with respect to the drawing plane of FIG. 11. Thereby the base body 25 of the blocking member 5 captures the normal position shown in FIG. 11, due to the spring 29 acting on the base body 25.

According to the second embodiment of the invention, the adjusting device 32 formed by the displacing member 5, blocking element 10 and ramp element 11 are designed as a structural unit having a circular cross section and being rotatable about an axis of rotation 48.

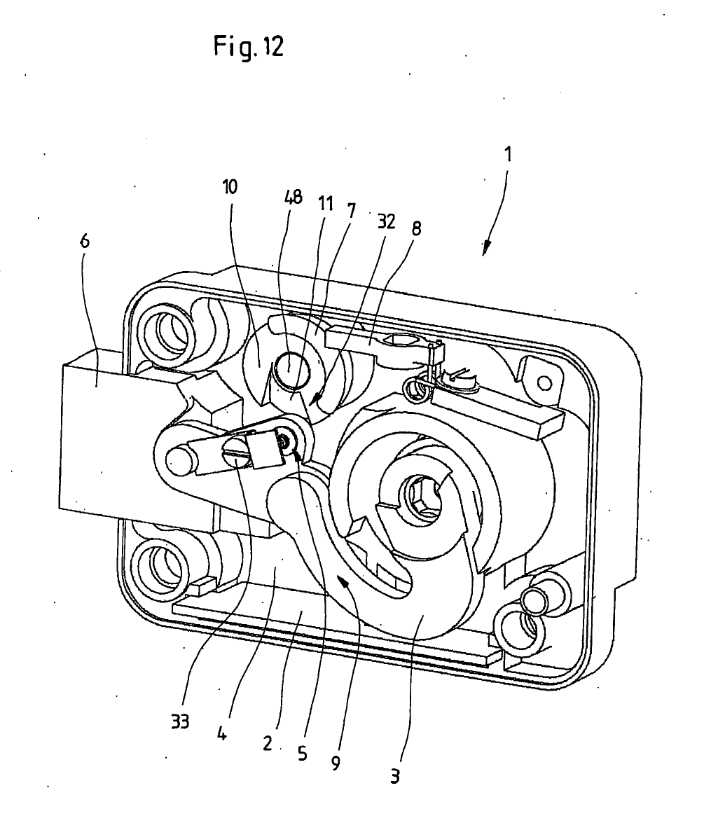

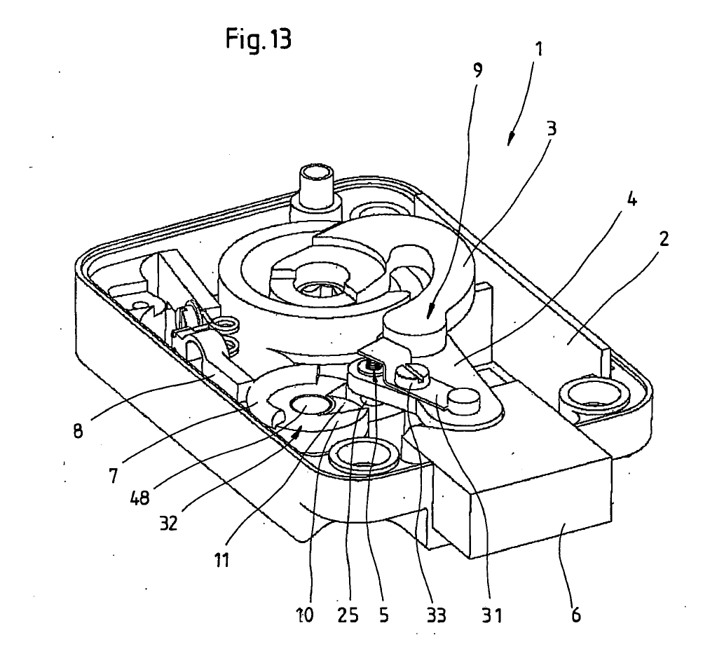

The FIGS. 10 and 11 show the lock 1 according to the invention with the bolt 6 extended and in the blocked position. An unblocked position of the lock 1 according to the invention with the bolt 6 extended is shown in the FIGS. 12 and 13.

The blocked position of the lock 1 according to the FIGS. 10 and 11 is characterized in that the displacing device 32 is in its blocking position in which the blocking element 10 run in the movement path which is described by the blocking member 5. Retracting the bolt 6 is not possible with the displacing device 32 in this position because the blocking member 5 arranged on the articulated arm 4 would strike against the blocking element 10 of the displacing device 32 during a displacing movement of the bolt-displacing device 9.

By means of the drive unit 8, which acts upon the displacing member 7, a rotary movement of the displacing device 32 is possible, namely in such a manner that instead of the blocking element 10 the ramp element 11 of the displacing device 32 run into the movement path which is described by the blocking member 5. This position is shown in the FIGS. 12 and 13.

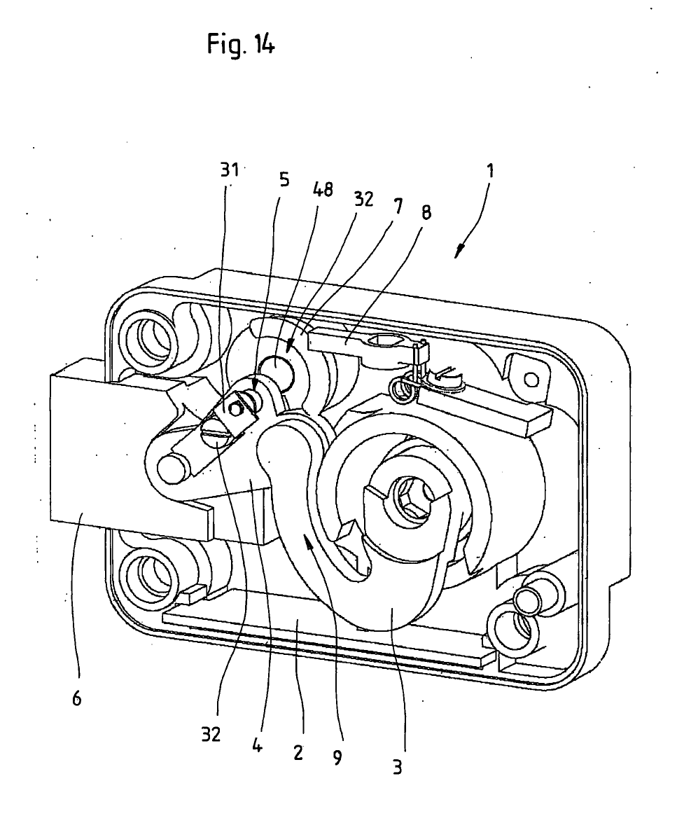

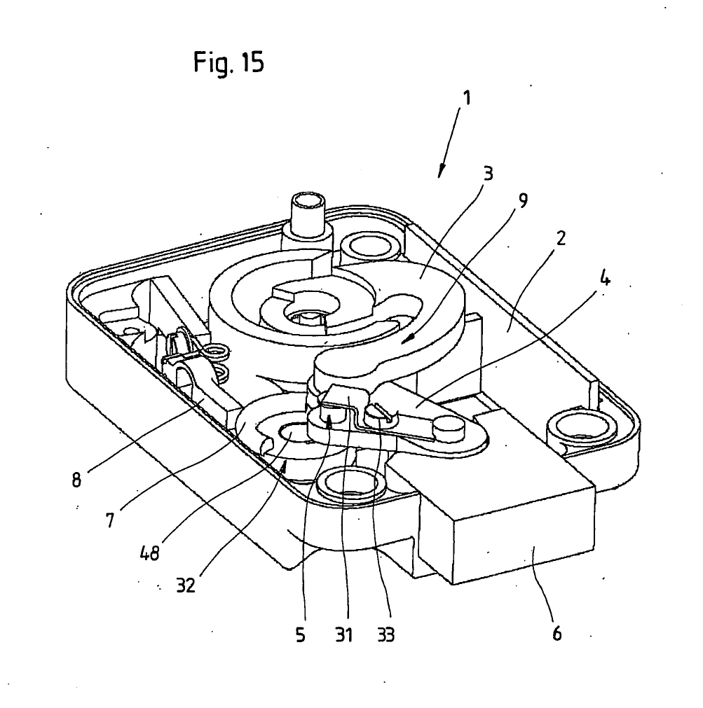

The FIGS. 14 and 15 show the bolt 6 in a position which is somewhat retracted compared to the FIGS. 10 to 13. Since the displacing device 32 is in the position described by way of the FIGS. 12 and 13, a rotary movement may be exerted on the pivoting arm 3 by means of an operating element not shown in the figures leading to a pivoting movement of the articulated arm 4 arranged for pivoting on the pivoting arm 3. A pivoting movement of the articulated arm 4 is possible because the blocking member 5 arranged on the articulated arm 4 is pushed up the ramp element 11 against the spring force acting on the base body 25 of the blocking member 5.

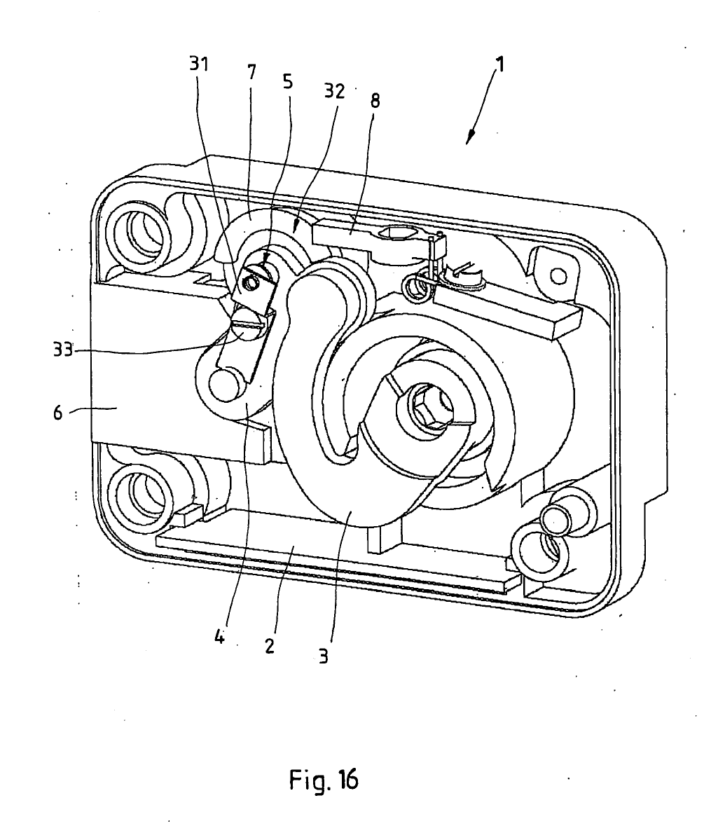

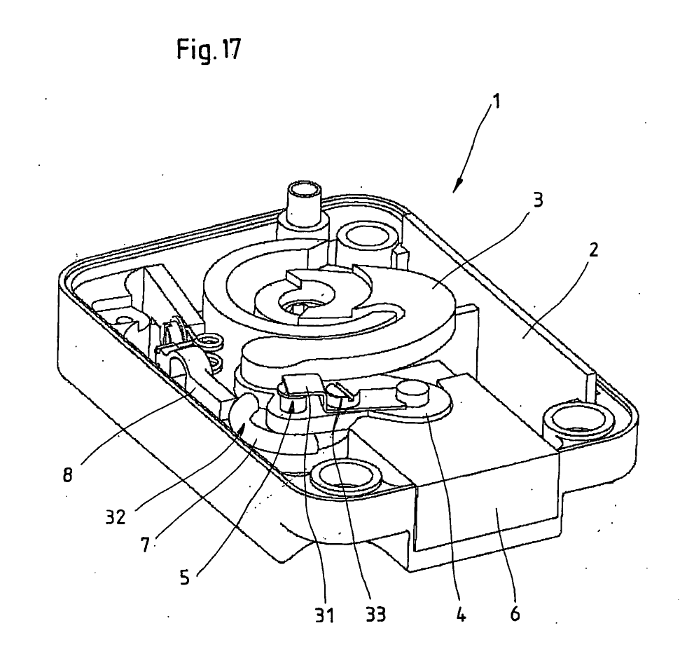

The FIGS. 16 and 17 finally show the lock 1 according to the invention with the bolt 6 fully retracted.

Concerning their function principle, the embodiments according to the FIGS. 1 to 9 on the one hand and the embodiments according to the FIGS. 10 to 17 on the other hand correspond to each other. The difference merely resides in the fact that in the embodiment according to the FIGS. 1 to 9 the displacing device 32 is designed for a linear movement, whereas the embodiment according to the FIGS. 10 to 17 provides for a displacing device 32 that can be rotated about an axis of rotation 48.

Based on the embodiment according to the FIGS. 10 to 17, the FIGS. 18 to 28 show a third and preferred embodiment. This third embodiment according to the FIGS. 18 to 28 is different from the second embodiment according to the FIGS. 10 to 17 by an additional mechanical emergency unlocking device which allows the bolt 6 being moved also by means of an operating element for instance in the form of a key 38.

The mechanical emergency unlocking device comprises a slider 34. The slider 34 is designed for sliding in the moving direction 13. By means of the key 38 the slider 34 can be moved to the left and to the right with respect to the drawing plane of FIG. 18 through a driving dog 37, as this is shown by a combined consideration of the FIGS. 18, 19 and 20.

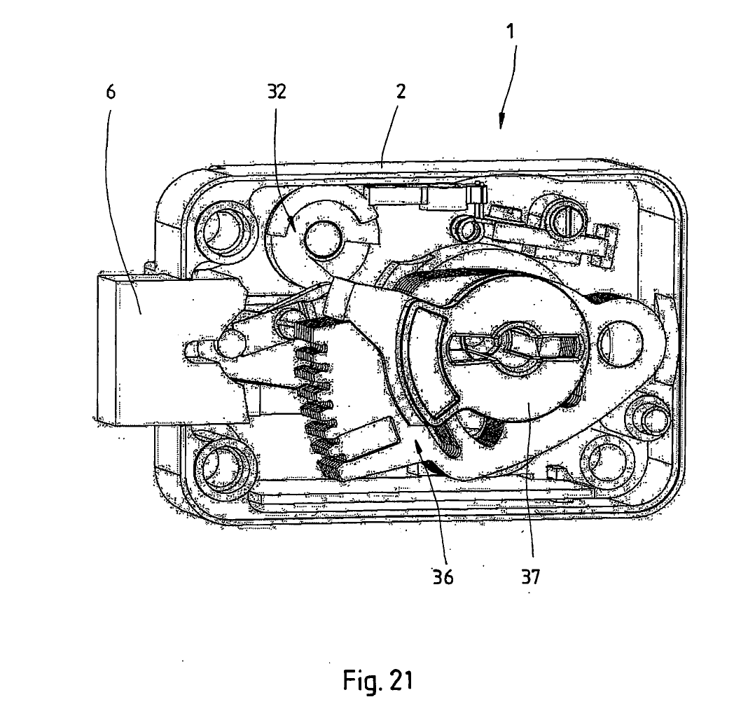

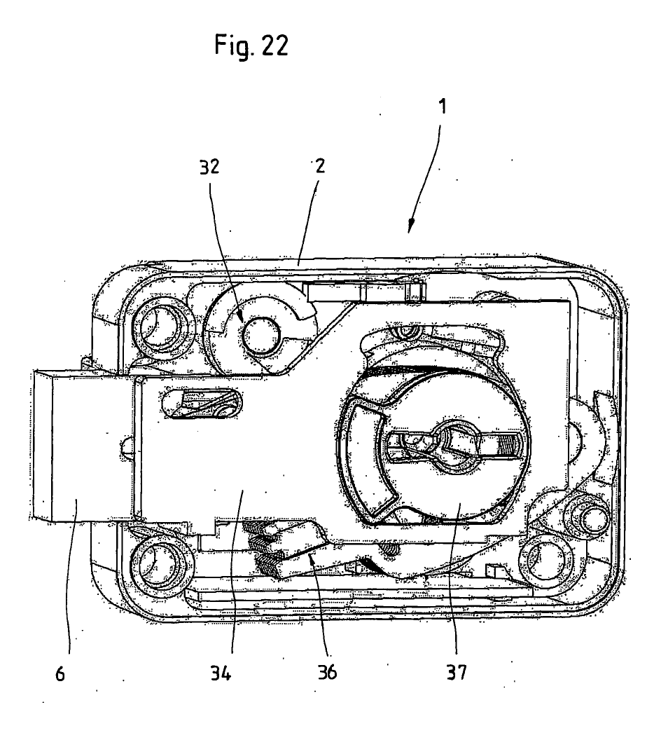

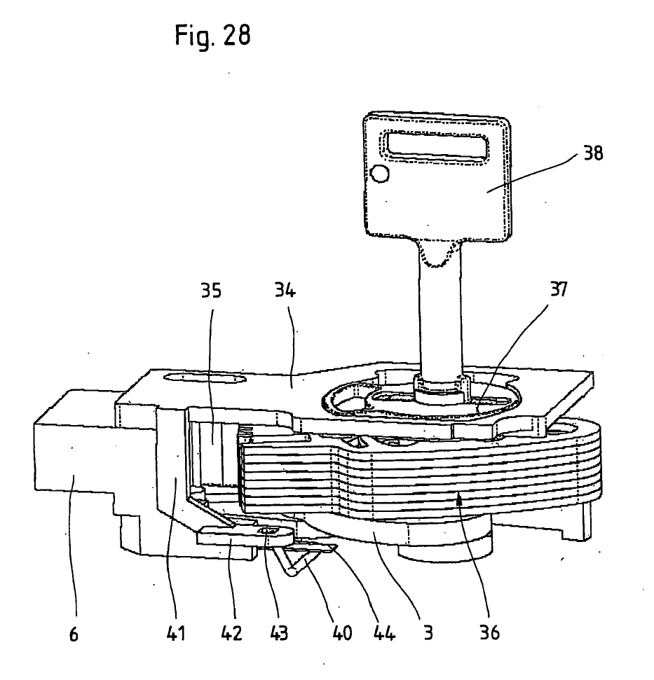

The tumblers 36 are arranged below the slider 34 with respect to the drawing plane of the FIGS. 21 and 22. When aligned for opening, these tumblers 36 provided a tour channel in a manner known by the art which can be entered by a tour pin 35 arranged on the rear side of the slider 34, as this can be seen particularly in the illustration according to FIG. 28.

In the exploded view according to FIG. 23, the individual structural components of the lock according to the invention are shown, including those for the mechanical emergency unlocking device. It can be seen in FIG. 23 that all the structural components are to be arranged within the housing part 2, the upper side of which can be closed by a cover 39. This cover 39 provides an opening (not further shown) for inserting a key 38 allowing a mechanical emergency unlocking device.

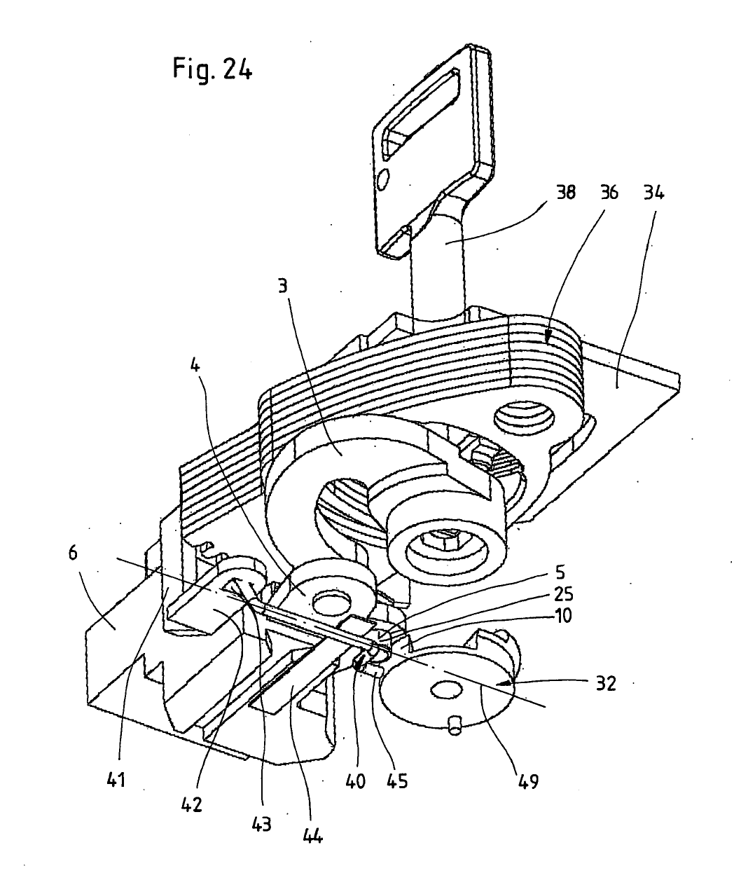

The slider 34 comprises an arm 41 which is joined by a bearing arm 42, as this is illustrated particularly in the FIGS. 24 and 28. The bearing arm 42 has an opening 43 on its one end which is engaged by an end portion of a lever arm 40. This lever arm 40 is supported for pivoting on the housing part 2, namely about a pivot axis 49, using a spring strip 44. Oppositely to the end portion engaging in the opening 43, the lever arm 40 has a further end portion 45. Upon rotation of the lever arm 40, this end portion 45 acts on the base body 25 of the blocking member 5 already described above.

FIG. 24 shows the lock according to the invention without the housing part 2 in a rear view. It can be seen that the blocking member 5 rests against the blocking element 10 of the displacing device 32. As already mentioned above, a movement of the bolt 6 is not possible in this position of the displacing device 32.

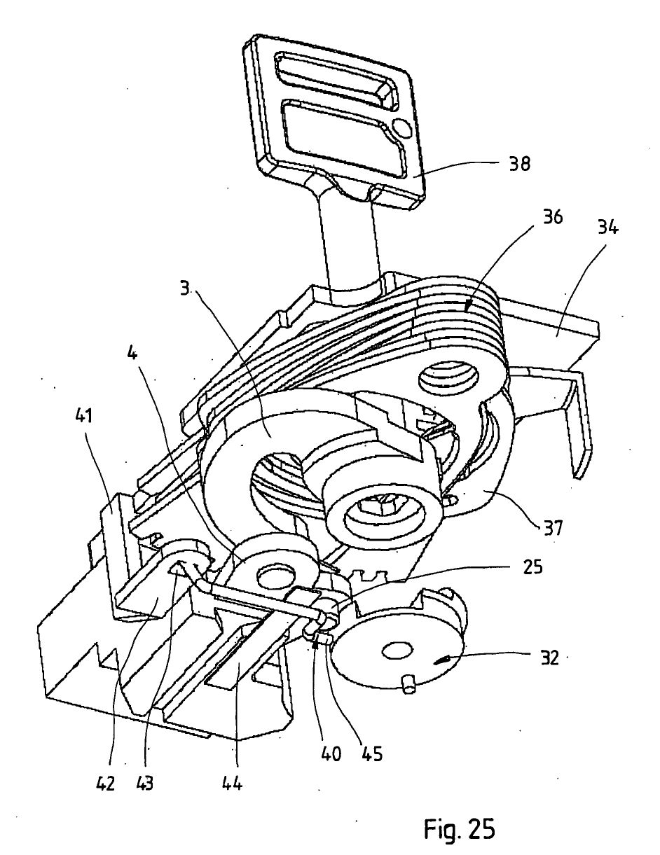

As a result of the mechanical emergency unlocking device, the lever arm 40 is pivoted about the pivot axis 49 in the longitudinal direction thereof which causes the end portion 45 pressing against the base body 25 of the blocking member 5 from below with respect to the drawing plane of FIG. 24 and thus pushing the base body upwards against the spring force of the spring 29 so that it can be pivoted across the blocking element 11. This is shown by the further FIGS. 25 to 27.

In summary, the mechanical emergency unlocking device operates as follows:

The bolt 6 of the lock 1 of the invention is in its extended position as shown for example in FIG. 18. Now the lock 1 is supposed to be opened, i.e. the bolt 6 shall be moved to the right in the moving direction 13 with respect to the drawing plane of FIG. 18. But this is not possible because the locking member 5 arranged on the bolt-displacing device 9 strikes against the blocking element 10 of the displacing device 32, i.e. the blocking element 10 blocks the mobility of the blocking member 5 and thus the bolt-displacing device 9. In order to allow a displacing movement of the bolt-displacing device 9, the displacing device 32 must be rotated in the above-described way, namely by means of the drive unit 8. This may be impossible because of the drive unit 8 being defective. Accordingly, the lock can be opened only through the mechanical emergency unlocking device.

For a mechanical emergency unlocking device the key 38 must be inserted in the lock. As a consequence of a rotation of the key 38, the tumblers 36 are rotated to their opening position, provided that the correct key 38 is used, i.e. the key that matches the lock 1 of the invention. At the same time, the slider 34 is moved to the right with respect to the drawing plane of FIG. 18 by means of the drive dog 37, and the movement of the slider 34 is possible because the tour pin 35 arranged on the underside of the slider 34 can plunge into the tour channel formed by the tumblers 36. If a key is used which does not match the lock 1 of the invention, the slider 34 cannot be moved to the right with respect to the drawing plane of FIG. 18, because in this case the tour pin 35 provided on the slider 34 would strike against the tumblers 36.

A displacement of the slider 34 to the right with respect to the drawing plane results in the lever arm 40 being rotated by means of the arm 41 or the bearing arm 42 provided thereon. As a result of the rotary movement, the end portion 45 of the lever arm 40 presses against the base body 25 of the blocking member 5 from below and, on continuation of this rotary movement, forces the blocking member 5 upwards with respect to the drawing plane 24 to an extent that it is lifted across the blocking element 10 which is in its blocking position. In this position, the lock according to the invention is unlocked by means of the mechanical emergency unlocking device. Now the bolt 6 can be retracted, although the displacing device 32 is still in its blockage position, since the blocking member 25 is lifted by the lever arm 24 a distance which allows the blocking member to move across the blocking element 10 when the articulated arm 24 is pivotally moved.

List of reference numbers

| | |
|---|---|
| 1 | lock |
| 2 | housing part |
| 3 | pivoting arm |
| 4 | articulated arm |
| 5 | blocking member |
| 6 | bolt |
| 7 | displacing member |
| 8 | drive unit |
| 9 | bolt-displacing device |
| 10 | blocking element |
| 11 | ramp element |
| 12 | movement path |
| 13 | moving direction |
| 14 | support bearing |
| 15 | connecting piece |
| 16 | bearing body |
| 17 | pin |
| 18 | bore |
| 19 | appendix |
| 20 | bore |
| 21 | limit stop |
| 22 | limit stop |
| 23 | portion |
| 24 | bore |
| 25 | base body |
| 26 | head |
| 27 | groove |
| 28 | safety washer |
| 29 | spring |
| 30 | guiding contour |
| 31 | retaining plate |
| 32 | displacing device |
| 33 | screw |
| 34 | slider |
| 35 | tour pin |
| 36 | tumblers |
| 37 | drive dog |
| 38 | key |
| 39 | cover |
| 40 | lever arm |
| 41 | arm |
| 42 | bearing arm |
| 43 | opening |
| 44 | spring strip |
| 45 | end portion |
| 46 | collar |
| 47 | guide pin |
| 48 | axis of rotation |
| 49 | pivoting axis |

1-12. (canceled)

13. An electronic lock, in particular safety lock, comprising
a bolt;
a bolt-displacing device connected with the bolt;
a blocking member arranged at the bolt-displacing device, the blocking member being movable and describing a movement path;
a blocking element interacting with the blocking member, the blocking element being designed to run into the movement path which is described by the blocking member; and
an emergency unlocking device.

14. The lock according to claim 13, wherein the blocking element run either linearly or on a circular path into the movement path which is described by the blocking member.

15. The lock according to claim 13, wherein the blocking member is spring-loaded.

16. The lock according to claim 15, wherein the blocking member is a spring-loaded element, preferably a stud, pin or piston or the like.

17. The lock according to claim 13, wherein the blocking element is arranged at a displacing member, said blocking element and said displacing member forming a common structural unit as a displacing device.

18. The lock according to claim 17, wherein the displacing device includes a ramp element.

19. The lock according to claim 13, wherein the blocking element can be pushed back again to a locking position by an opening movement of the bolt.

20. The lock according to claim 17, wherein the displacing device is formed bar-shaped or circular.

21. The lock according to claim 17, wherein the displacing device is designed to be linearly movable or rotatable about a center of rotation by means of a drive unit.

22. The lock according to claim 21, wherein drive unit is a linear drive or a rotary drive.

23. The lock according to claim 21, wherein the drive unit includes a piezo element.

24. The lock according to claim 13, wherein the mechanical emergency unlocking device includes a lever arm which, upon an actuation of the emergency unlocking device, acts on the blocking member.
